(19) United States
(12) Patent Application Publication
(10) Pub. No.: US 2023/0270132 A1
(43) Pub. Date: Aug. 31, 2023

(54) SUGAR-COATED CONFECTIONERY WITH IMPROVED CRUNCHINESS

(71) Applicant: ROQUETTE FRERES, LESTREM (FR)

(72) Inventors: André Busolin, LAMBERSART (FR); Patrice Demeulemeester, LINSELLES (FR)

(21) Appl. No.: 18/003,515

(22) PCT Filed: Jun. 18, 2021
(86) PCT No.: PCT/EP2021/025214

§ 371 Date: Dec. 28, 2022

(30) Foreign Application Priority Data
Jun. 30, 2020 (FR) FR2006907

(51) Int. Cl. A23G 4/20; A23G 4/10; A23G 4/02

(52) U.S. Cl. CPC A23G 4/20; A23G 4/10; A23G 4/025

(57) ABSTRACT

The invention relates to the use of a mixture of at least one sweetening agent and at least one chemically unmodified pregelatinized starch to improve the crunchiness of the hard crystalline coating of a sugar-coated product, said starch not having undergone chemical modifications, said coating and said mixture comprising less than 1% by weight of gum arabic relative to the total dry weight of the coating or of the mixture, preferably said coating or said mixture being free of gum arabic. The invention also relates to a sugar-coated confectionery product, a production method and a pre-mixed composition.

### TECHNICAL FIELD

The subject matter of the invention is the use of a new particular mixture of at least one sweetening agent and at least one chemically unmodified pregelatinized starch in a hard crystalline coating. It also relates to a sugar-coated confectionery product comprising a hard crystalline coating based on such a mixture, a method for producing a hard crystalline coating around a core by hard sugar-coating, said hard crystalline coating being based on said particular mixture and a dry premixed sugar-coating composition comprising such a mixture.

### PRIOR ART

Hard sugar-coating is a unitary operation used in many fields, including the confectionery and pharmacy fields. It may also relate to the additive industry such as flavorings, sweeteners, vitamins, enzymes, acids and plant-based products. This operation consists in creating a hard crystalline coating on the surface of solid products, in order to protect them for various reasons or even in order to make them visually or gustatorily attractive. Very generally, this unitary operation is carried out by placing such products as cores to be coated in a sugar-coating turbine.

Hard sugar-coating requires the use of at least one syrup and/or of a suspension containing crystallizable materials. The hard and crystalline coating is then obtained by applying this syrup or this suspension onto the cores and evaporating the water they yield by virtue of dry air drying, which causes the crystallization. Between the different applications of such a syrup or of such a suspension, powders containing crystallizable materials also can be applied by spraying.

This application-drying cycle must be repeated many times, of the order of ten to eighty times, in order to obtain the desired rate of enlargement.

The “rate of enlargement” represents the increase in weight of the products, considered at the end of the operation compared to the beginning, relative to the final weight of the products. Hard sugar-coating may be preceded or followed by other coating techniques. In particular, the following techniques that are often also carried out by using a sugar-coating turbine can be selected:
gumming, which is a technique in which syrups of non-crystallizable materials and generally non-hygroscopic materials are used, such as gums arabic, starches and modified celluloses, maltodextrins. This technique allows, after one or two applications of the gumming syrup on the product to be coated, a vitreous film to be created forming a barrier to the migration of oxygen, water or fats. Various types of powders also can be used in this method in conjunction with these non-crystallizable syrups, so as to fix the water the syrups yield. In yet more cases, sugars or polyols that are melted or liquefied by solvents are used. The hard and brittle vitreous coating is then obtained by cooling or by evaporating the solvents.
soft sugar-coating, which consists in creating a very flexible and soft coating on the surface of the products. This coating is obtained by repeated applications of a non-crystallizable syrup, such as starch hydrolysates, in general, and optionally of a powder, in general, crystallized sucrose. The coating is usually thick. The rate of enlargement for this technique is of the order of 10 to 80% or even more. It should be noted that the constituent material of the syrup is usually different from that of the powder.
glossing, which consists in using fatty substances or waxes generally provided in crystallized form as flakes or alcoholic solutions, to coat the products with a very fine fatty film in order to reduce transfers of water from or to the coated products but also to embellish their surface.

The term hard sugar-coating used in the present invention also includes the very similar techniques of smoothing and glazing.

Smoothing consists in one or more application(s) or filler(s) of a crystallizable syrup diluted with respect to that used in hard sugar-coating. Often, the aim is to perfect the surface appearance of sugar-coated products.

Glazing for its part also aims to improve the appearance of the products, but also to isolate them from the moisture in the atmosphere. This technique resembles hard sugar-coating, in that a crystallizable syrup is used. The basic difference lies in the fact that the number of cycles carried out is only one, two or only three.

Therefore, within the scope of the present invention, sugar-coating per se, smoothing, glazing and also these combined techniques are of interest. Hard sugar-coating is often followed by smoothing.

### Technical Problem

Coating methods have been applied using polyols.

The term “polyol” is understood to mean sugar-alcohols obtained by reducing sugars.

With a sweetened flavor that is generally below that attributed to the sucrose that they tend to replace in human food, but also in pharmaceutical and dietetic formulations, polyols have the advantage of having a calorific value that in Europe is set to approximately two thirds of that of sugar.

Many documents set forth the possibility of carrying out hard sugar-coating by using a polyol, such as maltitol, insofar as the purity of this polyol is very high. This is particularly the case:
of patent EP 201412, owned by the applicant, which discloses both a sugar-coating method using a maltitol syrup with purity exceeding 92% and a product with a hard crystalline coating containing at least 90% of maltitol.
and patent application JP 61263915 in the name of HAYASHIBARA, relating to the use of hard sugar-coating of a syrup containing maltitol with purity of more than 90% and a cohesion agent.

With respect to hard-sugar coating with xylitol, the requirement to use high-purity xylitol is mentioned directly or indirectly in the following documents:
patent FR 2,342,668 by FERRERO, which also states that it is essential to use xylitol that contains at most 5% of other polyols such as sorbitol and/or mannitol;
U.S. Pat. No. 4,127,677 in the name of LIFE SAVERS, which recommends using a solution containing on a dry basis 95 to 99.5% of xylitol, obtained by cold dissolution of crystalline xylitol, then heating the mixture;
the document entitled “FOOD TECHNOLOGICAL EVALUATION OF XYLITOL” by F. VOIROL, ADVANCES in FOOD RESEARCH, 1982, vol. 28, 373-403, which simply states that it is advantageous to prepare an oversaturated solution with 85% of solids as xylitol;
patent EP 273,000 by WARNER-LAMBERT Company, which describes an edible product coated with a coating made up of 40 to 70% of xylitol, with the difference to 100% being formed by at least one film-forming agent, at least one binder and at least one mineral nature bulking agent, and optionally at least one plasticizer;
and patents U.S. Pat. Nos. 4,681,766 and 4,786,511, also owned by WARNER-LAMBERT Company, which describe a hard sugar-coating solution and a sugar-coating both containing 30-80% of a sweetener, preferably xylitol, 1-15% of gum arabic and 0.05-10% of a calcium salt.

With respect to sugar-coating with isomalt, patents U.S. Pat. Nos. 4,792,453 and 5,248,508 from WRIGLEY are also known where, isomalt, acting only as polyol, is dissolved in water in order to prepare the sugar-coating solutions.

In the case of mannitol, even though application EP 308,317 filed by SANOFI states the possibility of producing a hard sugar-coating with mannitol, yet without actually providing the conditions of such an operation, it would appear to be very difficult to achieve. This is confirmed by the document by F. DEVOS entitled, “Coating with sorbitol, a comparison of properties of sorbitol-mannitol, polyol and sucrose” in The Manufacturing Confectioner, 1980, vol. 60 pg 26, where the author explains that the solubility of the mannitol is too low to allow good hard sugar-coating conditions and that too much water would then need to be evaporated. This explains the reason why it has never existed a priori on the sugar-coated with mannitol product market.

A sugar-coating technique especially described in patents and patent applications U.S. Pat. No. 5,270,061; WO 93/18663, WO 95/07621 and WO 95/07622 by WRIGLEY, consists in “dual” or “double” sugar-coating. It involves starting the sugar-coating with a syrup containing a pure polyol such as xylitol, maltitol or lactitol and then continuing and ending with the use of another polyol syrup, which is also pure but of a different nature than the first polyol, such as isomalt. This double-sugar coating technique basically aims to reduce the cost of the sugar-coating by partially substituting a polyol with another and reducing the hygroscopicity of the sugar-coated layer. However, it seems to be very expensive in terms of time and to be difficult to implement industrially.

Another technique described in patent application EP 625,311, owned by the applicant, relates to successive applications of a high-purity polyol syrup and of a powder containing the same polyol in the pure state and not completing, as is normal practice, forced drying by dry and hot air in the sugar-coating turbine. This method allows the sugar-coating times to be significantly reduced and relatively crunchy coatings to be obtained after being stored for a few hours.

One of the disadvantages of the use of polyol-based syrups, such as xylitol or isomalt, lies in the fact that these polyol syrups are not opacifying and yield a marbled effect if the core to be coated is not smooth and of uniform color.

It has very often been recommended for other substances to be incorporated into the sugar-coating syrups in addition to polyols. This is the case, for example, in patent EP 229,594 by WARNER-LAMBERT, which recommends combining polyvinylpyrrolidone with the retained polyol.

Other authors have proposed using, besides gelatin and gum arabic, used in sugar-coating for many years, binders such as modified celluloses, glucose syrups, pullulan or various gums, at relatively low rates, generally less than 5% by dry weight. It has been found that these substances improve the adhesion of the sugar-coated layer to the core and also the cohesion of the sugar-coated layer. These features also act on the crunchiness to a certain extent.

Thus, compositions comprising a starch as a binding agent have been proposed. Document US2010316759 relates to sugar-free coated products comprising a core and a coating, with the coating comprising native rice starch, at least one polyol and an additive, such as gum arabic. Other examples of documents relating to products coated with a mixture based on a polyol and gum arabic are WO94/16575, WO94/14331, EP0506251 and U.S. Pat. No. 4,317,838.

Document US20180000112 proposes coating compositions comprising pregelatinized pea starch that has undergone chemical modifications, at least one polyol and gum arabic. Document U.S. Pat. No. 3,527,646 for its part describes products coated with an amorphous film of a mixture of pregelatinized starches and sucrose in small amounts to improve the barrier properties of the coated product to the fats and air. Document US2013052252 also describes a coated product for which the coating comprises a pregelatinized starch and granulated sugar, which is not used in a hard crystalline coating layer. The product is also coated with a gum arabic-rich syrup and the coating thus formed comprises 1.9% of gum arabic. This document does not suggest forming confectioneries free of gum arabic. This document also does not mention the nature of the pregelatinized starch nor any improvement in the crunchiness linked to the use of the coating comprising it.

Thus, the binding agent in sugar-free products is almost exclusively commercially represented by gum arabic. It is easy to use, natural, ensures good adhesion between the sugar-coating and the core. Furthermore, it allows coatings with good crunchiness to be obtained, which is a particularly sought after advantage for the sugar-coated products.

Gum arabic is a high molecular weight polysaccharide with an unusually low viscosity, which behaves like a Newtonian liquid up to a concentration of 35%; it dissolves at concentrations of 55% to 60% in order to form a thick syrup. This low viscosity is attributed to its structural branching, which in fact makes it a globular molecule. This branching prevents the formation of micelles, contrary to the linear gums, minimizing the intermolecular hydrogen bond when it is hydrated in water. Consequently, it forms a weak film. Its solution becomes sticky at high concentrations but yields a brittle texture when it is dried. It forms a glossy film when it is poured onto a surface that cracks into a single pattern. It has an emulsifying property attributed to the presence of proteins covalently bound to a portion of the polysaccharide fraction forming a complex of glycoproteins with a very high molecular weight of more than 2 million Daltons.

Gum Arabic is also used for the hard sugar-coating of chewing gums and confectioneries coated with chocolate for binding and reinforcing the coating that is made up of sugar or sugar alcohols. It is added to the syrup recipe so that it can be distributed on the centers by spraying or manually. The gum arabic is only used in the first layers for cost reasons, or in all the layers, in particular in sugar-free sugar-coatings to help build a solid coating layer around chewing gum centers. The need for a good binder in coating syrups is required due to the industrial scale use of larger coating turbines in order to increase capacity, which results in cracking or even breaking of the sugar-coated coating when the centers fall into the turbine. In many cases, the cracking also occurs during packaging, when transporting the finished product and when consumers shake the packaging container.

In edible film and flake applications where the viscosity, clarity and cracking pattern of the specific film and also the adhesion/release of the casting strip are critical, gum arabic is currently the gum material predominantly used for this purpose.

Due to the uniqueness of gum arabic, the solutions to replace it in various uses such as food, pharmaceutical and industrial applications are rare. Consequently, it is worthwhile finding other solutions for replacing gum arabic.

An alternative making it possible to substitute gum arabic while seeking to retain the same properties of the final sugar-coated product is proposed in document EP2666368. Thus, gum arabic is replaced with other gums, such as xanthan gum or locust bean gum, by polysaccharides, such as pectin, agar, modified starches, such as, for example, maltodextrins.

In the case of pectins, one of the disadvantages is that sugar-coating is more brittle, which generates numerous broken corners during production.

Another alternative to the use of gum arabic as a coating reinforcing agent is provided in document US2004/0156993. To this end, a sugar-coating mixture based on a polyol and on a chemically modified starch by oxidation and/or treated with an acid is proposed.

However, it would appear that adding such viscous substances significantly disrupts the crystallization of the polyol used, so that the sugar-coated layer exhibits lower crystallinity. This would explain the reason that it then tends to become sticky. Furthermore, these substances do not allow sugar-coating times to be reduced, quite the opposite in fact.

Apart from searching for means aimed at reducing the costs of hard sugar-coating with polyols and especially at reducing the sugar-coating times, solutions are often sought that are aimed at increasing the crunchiness and the crispness of sugar-coated coatings with polyols. These factors, like the taste, act directly on the level of acceptance of the products and on renewed purchases by consumers.

The known solutions disclosed above do not ensure that both hardness and improved crunchiness of sugar-coated crystalline coatings with polyols are obtained, while providing a satisfactory visual appearance in terms of color and uniformity, adhesion of the layers within the coating and storage stability over time.

Therefore, it is to the applicant's credit to have found that this requirement for sugar-coated crystalline coatings with polyols for use in terms of improving crunchiness could be achieved, against all expectations, with a chemically unmodified pregelatinized starch. This coating has little or no gum arabic while it was known to date that the latter was essential for obtaining crystalline coatings with significant crunchiness and good adhesion and hardness properties.

### SUMMARY OF THE INVENTION

To this end and according to a first aim, the invention proposes using a mixture of at least one sweetening agent and at least one chemically unmodified pregelatinized starch to improve the crunchiness of the hard crystalline coating of a sugar-coated product, with said starch not having undergone chemical modifications, said coating and said mixture comprising less than 1% by weight of gum arabic relative to the total dry weight of the coating or the mixture, preferably with said coating or said mixture being free of gum arabic.

According to another subject matter, a sugar-coated confectionery product including a hard crystalline coating comprising a mixture of at least one sweetening agent and at least one chemically unmodified pregelatinized starch is proposed, said starch not having undergone chemical modifications, said coating and said mixture comprising less than 1% by weight of gum arabic relative to the total dry weight of the coating or the mixture, preferably with said coating or said mixture being free of gum arabic.

According to another subject matter, a method is proposed for producing by hard sugar-coating a hard crystalline coating around a core, the method comprising the following steps:
preparing a sugar-coating syrup by mixing at least one sweetening agent and at least one chemically unmodified pregelatinized starch with a solvent,
creating a crystalline coating on the surface of the core by at least one application of said sugar-coating syrup;
   with said starch not having undergone chemical modifications,
   said coating and said syrup thus prepared comprising less than 1% by weight of gum arabic relative to the total dry weight of the coating or to the total weight of the syrup, preferably with said coating or said syrup thus prepared being free of gum arabic.

According to another subject matter, a dry premixed composition of sugar-coating is proposed comprising a mixture of at least one sweetening agent and at least one chemically unmodified pregelatinized starch, with said starch not having undergone chemical modifications,

said composition comprising less than 1% by weight of gum arabic relative to the total weight, preferably with said composition being free of gum arabic.

According to the invention, the mixtures, the syrup, the coating and the pre-mixed composition comprise:
between 80 and 99.90% by weight of said sweetening agent relative to the total mass of solids of the mixture, preferentially between 90 and 99.90% and
between 0.1 and 20% by weight of said starch relative to the total mass of solids of the mixture, preferentially between 0.1 and 10%.

The features disclosed in the following paragraphs optionally may optionally be implemented. They may be implemented independently of one another or in combination with one another.

### DISCLOSURE OF THE INVENTION

A first subject matter of the invention relates to the use of a mixture of at least one sweetening agent and at least one chemically unmodified pregelatinized starch to improve the crunchiness of the hard crystalline coating of a sugar-coated product, with said starch not having undergone chemical modifications,

said coating and said mixture comprising less than 1% by weight of gum arabic relative to the total dry weight of the coating or the mixture, preferably with said coating or said mixture being free of gum arabic.

Said starch therefore has not undergone chemical modifications such as oxidation or chemical grafting.

“Pregelatinized” starch or “pregel” starch is understood to mean a starch that has been cooked and then dried in starch making the starch soluble in cold water (“cold water soluble starch”), this cooking can be carried out on a drying drum or in an extruder.

Pregelatinizing starch is an operation that is well known to a person skilled in the art in which the cooking is generally carried out at a temperature below the gelatinization temperature of the starch.

It is known that starch is stored in reserve storage organs and tissues in a granular state, that is, in the form of semi-crystalline granules. This semi-crystalline state is basically due to the presence of amylopectin macromolecules.

In the native state, the starch grains have a rate of crystallinity that varies from 15 to 45% and that basically depends on the botanical origin and any treatment that it has undergone. Granular starch, placed under polarized light, thus has, in microscopy, a characteristic black cross referred to as “Maltese cross”. This phenomenon of positive birefringence is due to the semi-crystalline organization of these granules: the average orientation of the polymer chains being radial.

For a more detailed description of granular starch, reference may be made to chapter II, entitled “Structure et morphologie du grain d'amidon” [“Structure and morphology of the starch grain”] by S. Perez, in the work “Initiation à la chimie et à la physico-chimie macromoléculaires” [“Introduction to macromolecule chemistry and physical chemistry”], first edition, 2000, volume 13, pages 41 to 86, Groupe Francais d'Etudes et d'Applications des Polymères [French Polymer Group].

Dry starch contains a water content that ranges from 12 to 20%, depending on the botanical origin. This water content obviously depends on the residual moisture of the medium (for an aw=1, the starch may fix up to 0.5 g of water per gram of starch).

Heating, with an excess of water, a starch suspension to temperatures close to its gelatinization temperature leads to irreversible swelling of the grains and leads to the dispersion thereof, then the dissolution thereof.

For a given temperature range, referred to as “gelatinization range”, the starch grain will very quickly swell and lose its semi-crystalline structure (loss of birefringence).

All the grains will be swollen to the maximum over a temperature range of the order of 5 to 10° C. A paste is obtained composed of swollen grains that constitute the dispersed phase and of dispersed molecules (corresponding mainly to amylose) that thicken the aqueous continuous phase. The rheological properties of the paste depend on the relative proportion of these two phases, dispersed and aqueous, and on the swelling volume of the grains. The gelatinization range is variable depending on the botanical origin of the starch.

“Chemically unmodified pregelatinized starch” is understood to mean a starch that has been cooked and then dried in starch making the starch soluble in cold water (“cold water soluble starch”), this cooking can be carried out on a drying drum or in an extruder, and which has not undergone chemical modifications. Examples of such chemical modifications are: crosslinking, oxidation, esterification, such as acetylation, phosphorylation, succination, etc., etherification, such as hydroxypropylation, hydroxyethylation, etc., reactions inside the starch during the formation of dextrins such as condensation or reversion, transglucosyl or even anhydrization reactions or any combination thereof.

A cold water-soluble starch solution can have a Brookfield viscosity of more than 100 mPa·s when 10 g of this starch is introduced into 90 g of water at 20° C., then the solution thus obtained is stirred for one hour.

Preferably, the coating obtained, or the mixture used for preparing the coating comprises less than 1% by weight of gum arabic relative to the total dry weight of the coating or of the mixture, preferably comprising less than 0.5% by weight of gum arabic relative to the total dry weight of the coating or of the mixture, said coating or said mixture, even preferably, with said coating or said mixture being free of gum arabic.

“Gum arabic” is understood to mean both the hard gum arabic (or kitir) and the brittle gum arabic (or talha).

Preferably, the coating obtained, or the mixture used for preparing the coating are free of polysorbate, or even of emulsifiers.

By using a mixture of at least one sweetening agent and at least one chemically unmodified pregelatinized starch to obtain a hard crystalline coating of a sugar-coated product, the crunchiness of said product is improved compared to the other binders. When the sugar-coated product is a sugar-coated confectionery product, it is an undeniable advantage during tasting. Indeed, a binder is necessary for the coatings with these polyols in order to give the coating more crunch when chewing, as well as to protect the coating from damage during treatment and handling.

As in the case of G. RIBADEAU DUMAS in their conference entitled, “Actual manufacturing possibilities for sugarless hard and soft coating: techniques—problems—solutions” in Süßwaren-Dragee-Tagung, May 1994, Solingen, Zentralfachshule der Deutschen Süßwarenwirtschaft e.V., crunchiness is a subjective and complex organoleptic magnitude, yet which may be understood by mechanical measurements of hardness and brittleness using an INSTRON type apparatus. It is for this reason that it was possible for them to objectively show that the crunchiness varies with the features of the core to be sugar-coated as with those of the sugar-coated layer.

In addition, surprisingly, the provision of chemically unmodified pregelatinized starch increases the hardness and the crunchiness of the finished product compared to gum arabic or other chemically modified starch or native modified starch that is not pregelatinized, but also, as demonstrated below, the whiteness index.

Preferably, the coating obtained or the mixture used for preparing the coating comprise less than 1.5%, for example, less than 0.5% by weight of titanium dioxide relative to the total dry weight of said coating or of said mixture, preferably less than 0.1% by weight of titanium dioxide relative to the total dry weight of said coating or of said mixture, even preferably, said coating or said mixture is free of titanium dioxide (TiO₂).

Titanium dioxide is a whitening agent commonly used in sugar-coating mixtures. Eliminating titanium dioxide from a hard coating leads to the following phenomena: loss of whiteness, less opaque coating, negative visual impact of the coloring of the core, less uniform appearance.

This particular starch thus allows gum arabic and titanium dioxide to be replaced while keeping the same functionalities thereof, for example, the role of binding agent, while allowing the whiteness and the sugar-coating to be improved. The present invention thus also relates to the use of chemically unmodified pregelatinized starch to improve the whiteness and/or the crunchiness of a hard crystalline coating of a sugar-coated product comprising a sweetening agent. This use is particularly interesting when said crystalline coating is free of gum arabic. This use is also particularly interesting when said crystalline coating is free of titanium dioxide. According to this variant, the amounts of gum arabic are not necessarily limited: in other words, the amount of gum arabic in the hard crystalline coating, the mixture and the premixed composition may be less than 1% by weight of gum arabic relative to the total dry weight but also 1% or more by weight of gum arabic relative to the total dry weight. The invention thus relates to the use of a mixture of at least one sweetening agent and at least one chemically unmodified pregelatinized starch to improve the crunchiness of the hard crystalline coating of a sugar-coated product, with said starch not having undergone chemical modifications, with said coating and said mixture being free of titanium dioxide. According to another subject matter, a sugar-coated confectionery product is proposed including a hard crystalline coating comprising a mixture of at least one sweetening agent and at least one chemically unmodified pregelatinized starch, with said starch not having undergone chemical modifications, with said coating and said mixture being free of titanium dioxide. According to another subject matter, a dry premixed composition of sugar-coating is proposed comprising a mixture of at least one sweetening agent and at least one chemically unmodified pregelatinized starch, with said starch not having undergone chemical modifications, with said composition being free of titanium dioxide. According to another subject matter, a method is proposed for producing a hard crystalline coating around a core by hard sugar-coating, the method comprising the following steps:
preparing a sugar-coating syrup by mixing at least one sweetening agent and at least one chemically unmodified pregelatinized starch with a solvent,
creating a crystalline coating on the surface of the core by at least one application of said sugar-coating syrup;
   with said coating and said syrup thus prepared being free of titanium dioxide.

For all these variants where the crystalline coating is free of titanium dioxide, the sweetening agent and the chemically unmodified pregelatinized starch are present in the preferred or non-preferred proportions defined in the present application. Thus, it is explicitly specified that, according to these variants, the mixtures, the syrup, the coating and the pre-mixed composition also comprise:
between 80 and 99.90% by weight of said sweetening agent relative to the total mass of solids of the mixture, preferentially between 90 and 99.90% and
between 0.1 and 20% by weight of said starch relative to the total mass of solids of the mixture, preferentially between 0.1 and 10%.

Preferably, the chemically unmodified pregelatinized starch has a viscosity ranging from 0.001 to 0.30 Pa·s, measured according to a test B, test B consisting in measuring the viscosity, determined at a frequency of 10 s-1 and at 20° C., of an aqueous solution at 5% by mass of pregelatinized starch.

The aqueous solution may be prepared in a hermetic glass jar, in which 95 g of water is weighed and put in a water bath at 70° C. 5 grams of pregelatinized starch is added with stirring (650 rpm) by a magnetic bar (slowly to avoid lumps). The solution thus obtained is left in a water bath at 70° C. for 12 hours.

After cooling the solution, the viscosity can be measured on an Anton Paar MCR301 rheometer equipped with CC27 concentric cylinders, for which the temperature of 20° C. is Peltier-regulated with a 5 minute equilibrium time before measuring, then shearing of 0.05 to 1,000 s-1 in 6 minutes (ramp log) is applied. The viscosity determined at a frequency of 10 s-1 is thus recorded.

Advantageously, the chemically unmodified pregelatinized starch has a viscosity ranging from 0.02 to 0.25 Pa·s, preferentially from 0.04 to 0.20 Pa·s according to test B, with test B consisting in measuring the viscosity, determined at a frequency of 10 s-1 and at 20° C., of an aqueous solution at 5% by mass of pregelatinized starch

Preferably, the chemically unmodified pregelatinized starch is a pregelatinized native starch having undergone only pregelatinization treatment.

“Pregelatinized native starch” is understood to mean a pregelatinized starch not having undergone other physical or chemical modifications, besides pregelatinization. More particularly, it is understood to be a pregelatinized starch not having undergone a fluidization treatment.

Preferably, the sweetening agent is a polyol.

Preferably, the polyol is selected from sorbitol, mannitol, maltitol, xylitol, isomalt, erythritol and lactitol or a mixture thereof, preferably maltitol or xylitol.

Thus, in the case of a sugar-free coating, the sweetening agent is especially a polyol that can be selected from sorbitol, mannitol, maltitol, xylitol, isomalt, erythritol and lactitol, preferentially maltitol, isomalt and xylitol, more preferentially maltitol, xylitol, most preferentially maltitol.

Moreover, a sweetening agent forming said mixture may be selected from at least one sugar or at least one polyol or a mixture thereof.

In the case of a coating with sugar, the sweetening agent especially can be a sugar selected from sucrose, dextrose, isomaltulose (palatinose), maltose and galactose, preferably, sucrose, dextrose or galactose, most preferentially sucrose.

Alternatively, in the case of a coating with sugar, the mixture may comprise at least two sweetening agents selected from at least one sugar and at least one polyol, with said sugar being selected from sucrose, dextrose, isomaltulose (palatinose), maltose and galactose, preferably sucrose, dextrose or galactose and said polyol being selected from sorbitol, mannitol, maltitol, xylitol, isomalt, erythritol and lactitol, preferentially maltitol, isomalt and xylitol, more preferentially maltitol, xylitol, most preferentially maltitol.

Preferably, the chemically unmodified pregelatinized starch is selected from pregelatinized, chemically unmodified pea starch, chemically unmodified pregelatinized corn starch or pregelatinized waxy corn starch.

Such chemically unmodified pregelatinized starches are sold under the brand name PREGEFLO®, such as, for example, under the name of Pregeflo® C100 Waxy, Pregeflo® M, Pregeflo® L100G by Roquette.

Preferably, said mixture comprises:
between 80 and 99.90% by weight of said sweetening agent relative to the total mass of solids of the mixture, preferentially between 90 and 99.90%, for example, between 91 and 99.80%, or even between 92.50 and 99.70%, or even between 93 and 99.60%, or even between 93.50 and 99.50%, or even between 94 and 99.40%, or even between 94.50 and 99.20%, most preferentially between 95 and 99% and
between 0, 1 and 20% by weight of said starch relative to the total mass of solids of the mixture, preferentially between 0.1 and 10%, for example, between 0.20 and 9%, or even between 0.30 and 7.50%, or even between 0.40 and 7%, or even between 0.50 and 6.50%, or even between 0.60 and 6%, or even between 0.80 and 5.50%, most preferentially between 1 and 5%.

Preferably, the mass ratio between the sweetening agent and the chemically unmodified pregelatinized starch ranges between 4 and 10,000, preferably between 10 and 1000, most preferentially between 20 and 100.

Preferably, the mixture is used for manufacturing coatings of sugar-coated products such as those indicated below, with these products also possibly including, in their coating or in a coating as obtained by means of the method for obtaining a crystalline coating by hard sugar-coating described below, ingredients such as flavoring agents, artificial sweeteners, dispersing agents and emulsifiers, coloring agents, whitening agents, film-forming agents and binding agents.

Preferably, the constituents of the mixture are powder, with the average size d50 of the powder ranging from 10 to 1,000 μm, for example, between 100 and 800 μm.

The d50 is determined on an LS 230 LASER diffraction granulometer by BECKMAN-COULTER, equipped with its powder dispersion module (dry route), following the technical manual and the specifications of the manufacturer. The measurement range of the LS 230 type LASER diffraction granulometer is from 0.04 μm to 2,000 μm.

A second subject matter of the invention relates to a sugar-coated confectionery product including a hard crystalline coating comprising a mixture of at least one sweetening agent and at least one chemically unmodified pregelatinized starch, with said starch not having undergone chemical modifications,

said coating and said mixture comprising less than 1% by weight of gum arabic relative to the total dry weight of the coating or the mixture, preferably with said coating or said mixture being free of gum arabic.

Said starch therefore has not undergone chemical modifications such as oxidation or chemical grafting

Preferably, the crystalline coating comprises a mixture of at least one sweetening agent and at least one chemically unmodified pregelatinized starch, such as that used according to the first subject matter.

Preferably, the pregelatinized starch that is used is obtained by pregelatinization, as described above.

Preferably, the coating obtained, or the mixture used for preparing the coating comprise less than 1% by weight of gum arabic relative to the total dry weight of the coating or of the mixture, preferably comprising less than 0.5% by weight of gum arabic relative to the total dry weight of the coating or of the mixture, said coating or said mixture, more preferably, with said coating or said mixture being free of gum arabic.

Preferably, the coating obtained, or the mixture used for preparing the coating are free of polysorbate, or even of emulsifiers.

Preferably, the coating obtained, or the mixture used for preparing the coating comprises less than 1.5%, for example, less than 0.5% by weight of titanium dioxide relative to the total dry weight of said coating or of said mixture, preferably less than 0.1% by weight of titanium dioxide relative to the total dry weight of said coating or of said mixture, more preferably, said coating or said mixture is free of titanium dioxide (TiO₂). One of the advantages of the invention is that, even when the coating comprises small amounts (or is free of) of titanium dioxide, the coating has improved whiteness compared to a coating comprising gum arabic. Similarly, when the coating further comprises colorings, the coloring of the coated product according to the invention is highly satisfactory.

The hard crystalline coating may, due to its high crunchiness, constitute an internal, intermediate or external coating of complex coatings such as those prepared by double sugar-coating or such as those composed of several sugar-coated layers with a different nature or texture.

Confectionery products that may comprise such a coating may be chewing gums, tablets, lozenges, gels, liquor eggs, chewable pastes, hard candies, chocolate products.

Alternatively, this coating may be produced by using very diverse products as a core to be sugar coated. It may be food products other than confectioneries such as dietetic products, dry fruit and seeds, but also pharmaceutical or veterinary products such as pills, tablets and products for animals.

Preferably, the sugar-coated confectionery product is a chewing gum.

Preferably, the chemically unmodified pregelatinized starch has a viscosity ranging from 0.001 to 0.30 Pa·s, advantageously from 0.02 to 0.25 Pa·s, preferentially from 0.04 to 0.20 Pa·s, measured according to a test B, with test B consisting in measuring the viscosity, determined at a frequency of 10 s-1 and at 20° C., of an aqueous solution at 5% by mass of pregelatinized starch.

Preferably, the chemically unmodified pregelatinized starch present in the crystalline coating is a pregelatinized native starch.

“Pregelatinized native starch” is understood to mean a pregelatinized starch not having undergone other physical or chemical modifications, besides pregelatinization. More particularly, it is understood to be a pregelatinized starch not having undergone a fluidization treatment.

The coating may be selected from a sugar or sugar-free coating, as described above.

Preferably, the sweetening agent is a polyol.

Preferably, the polyol is selected from sorbitol, mannitol, maltitol, xylitol, isomalt, erythritol and lactitol or a mixture thereof, preferably maltitol or xylitol.

Preferably, the chemically unmodified pregelatinized starch is selected from pregelatinized chemically unmodified pea starch, pregelatinized chemically unmodified native corn starch or pregelatinized chemically unmodified native waxy corn starch.

Preferably, said mixture comprises:
between 80 and 99.90% by weight of said sweetening agent relative to the total mass of solids of the mixture, preferentially between 90 and 99.90%, for example, between 91 and 99.80%, or even between 92.50 and 99.70%, or even between 93 and 99.60%, or even between 93.50 and 99.50%, or even between 94 and 99.40%, or even between 94.50 and 99.20%, most preferentially between 95 and 99% and
between 0, 1 and 20% by weight of said starch relative to the total mass of solids of the mixture, preferentially between 0.1 and 10%, for example, between 0.20 and 9%, or even between 0.30 and 7.50%, or even between 0.40 and 7%, or even between 0.50 and 6.50%, or even between 0.60 and 6%, or even between 0.80 and 5.50%, most preferentially between 1 and 5%. Preferably, the weight ratio between the sweetening agent and the chemically unmodified pregelatinized starch ranges between 4 and 10,000, preferably between 10 and 1,000, most preferentially between 20 and 100.

Preferably, the constituents of the mixture are powder, with the average size d50 of the powder ranging from 10 to 1,000 μm, for example, between 100 and 800 μm.

Preferentially, the chemically unmodified pregelatinized starches are the only binding agents of the sugar-coating syrup.

A third subject matter of the invention relates to a method for producing a hard crystalline coating around a core by hard sugar-coating, the method comprising the following steps:
preparing a sugar-coating syrup by mixing at least one sweetening agent and at least one chemically unmodified pregelatinized starch with a solvent,
creating a hard crystalline coating on the surface of the core by at least one application of said sugar-coating syrup, with said starch not having undergone chemical modifications, said coating and said syrup thus prepared comprising less than 1% by weight of gum arabic relative to the total dry weight of the coating or to the total weight of the syrup, preferably with said coating or said syrup thus prepared being free of gum arabic.

Said starch therefore has not undergone chemical modifications such as oxidation or chemical grafting

Preferably, the solvent used for preparing the sugar-coating syrup is water.

Preferably, the coating obtained or said syrup thus prepared comprise less than 1% by weight of gum arabic relative to the total dry weight of the coating or of the mixture, preferably comprising less than 0.5% by weight of gum arabic relative to the total dry weight of the coating or of the mixture, said coating or said mixture, more preferably, said coating or said mixture being free of gum arabic.

Preferably, the coating obtained or said syrup thus prepared are free of polysorbate, or even of emulsifiers.

Preferably, the coating obtained or said syrup thus prepared comprises less than 1.5%, for example, less than 0.5% by weight of titanium dioxide relative to the total dry weight of said coating or of said syrup, preferably less than 0.1% by weight of titanium dioxide relative to the total dry weight of said coating or of said syrup, more preferably, said coating or said mixture is free of titanium dioxide (TiO₂).

Preferably, the pregelatinized starch that is used is obtained by pregelatinization, as described above.

Preferably, the chemically unmodified pregelatinized starch has a viscosity ranging from 0.001 to 0.30 Pa·s, advantageously from 0.02 to 0.25 Pa·s, preferentially from 0.04 to 0.20 Pa·s, measured according to a test B, with test B consisting in measuring the viscosity, determined at a frequency of 10 s-1 and at 20° C., of an aqueous solution at 5% by mass of pregelatinized starch.

Preferably, the chemically unmodified pregelatinized starch is a native starch.

The coating may be selected from a sugar or sugar-free coating, as described above.

Preferably, the sweetening agent is a polyol.

Preferably, the polyol is selected from sorbitol, mannitol, maltitol, xylitol, isomalt, erythritol and lactitol or a mixture thereof, preferably maltitol or xylitol.

Preferably, the chemically unmodified pregelatinized starch is selected from pregelatinized, chemically unmodified pea starch, chemically unmodified pregelatinized corn starch or pregelatinized waxy corn starch.

Preferably, the sugar-coating syrup comprises from 30% to 85% by weight of solids relative to the total weight of the syrup.

Preferably, the constituents of the mixture are powder, with the average size d50 of the powder ranging from 10 to 1,000 μm, for example, between 100 and 800 μm.

The sugar-coating syrup can have a solids content that varies according to the step of forming the hard crystalline coating (smoothing, magnifying, etc.) and also the nature of the selected constituents. It is carried out so as to be able to easily apply the syrup during the method. The solids of the solution is generally between 30 and 85%, advantageously between 60 and 80%. Preferably, the solids content ranges between 65-80% by weight of solids relative to the total weight of the syrup, in the case of an enlargement syrup or between 60 and 70% by weight of solids relative to the total weight of the syrup, in the case of a smoothing syrup.

In the conventional methods, the syrup is generally prepared in two steps:

The Preparation of the Binding Agent.

Generally, a solution is prepared beforehand to facilitate the hydration of the starch. This starch solution can have solids content ranging from 10 to 25%, for example, of the order of 20%.

Preferably, the solution that is obtained is transparent and uncolored.

Dissolution of the Filler(s).

In another tank, the necessary amount of water needs to be introduced and the sweetening agent (the polyol) needs to be added.

Heating is then required in order to reach total dissolution of the material. The final temperature of the syrup depends on the desired solids, the solubility of the component or components and the maximum viscosity in order to ensure use without any risk of crystallization. For example, for a maltitol syrup with 70% solids, the usage temperature is generally 70° C.

The Composition of the Final Syrup.

The two solutions are then combined. The solids content is adjusted if necessary. Other components may be added to the final solution or one of the preceding solutions such as powder or liquid colorings, intense sweetener, anti-foaming agents, flavorings, minerals, whitening agents.

Preferably, the sugar-coating syrup is prepared at a temperature below 100° C., preferably below 80° C.

A temperature below 100° C., preferably below 80° C., therefore allows the sweetening agent to dissolve.

The chemically unmodified pregelatinized starch used according to the invention can be dissolved cold, that is, at a temperature roughly below 40° C., or even at a temperature below 30° C., for example, at room temperature.

Preferably, the solvent is water.

Thus, the sugar-coating syrup can be prepared in a single step by obtaining a dry mixture from the sweetening agent and from the chemically unmodified pregelatinized starch, adding the solvent and heating until the sweetening agent is dissolved. Likewise, other components may be added to the final solution or one of the preceding solutions, such as powder or liquid colorings, intense sweetener, anti-foaming agents, flavorings, minerals, whitening agents.

The preparation of a sugar-coating syrup based on chemically unmodified pregelatinized starch is therefore simplified by virtue of the greater solubility of said starch in water compared with other binding agents.

For example, preparing a non-pregelatinized native starch-based syrup would require prior cooking at a temperature above 100° C.

As for gum arabic, it does not dissolve easily, and it is therefore very difficult to mix sweetening agent powders, such as polyol or sugar, and gum arabic before heating. Heating would then be required until the sweetening agent completely dissolves in water, then the previously prepared aqueous solution of gum arabic would need to be added, with the preparation thereof requiring a stirring time and a standing time for additional bubble removal compared with the solution based on chemically unmodified starch.

Thus, preferably, the polyol is in powder form and the sugar-coating syrup is prepared by mixing the polyol, the chemically unmodified pregelatinized starch with the solvent, with the mixture then being heated.

Preferably, the sugar-coating syrup has a viscosity between 0.1 and 5 Pa·s measured according to Test A at 20° C., preferentially between 0.5 and 3 Pa·s.

Preferably, the sugar-coating syrup has a viscosity between 0.02 and 0.7 Pa·s measured according to Test A at 70° C., preferentially between 0.04 and 0.6 Pa·s.

The conditions that can be used to carry out Test A are indicated in the ‘Measuring method and equipment’ section.

Preferably, said syrup comprises:
between 80 and 99.90% by weight of said sweetening agent relative to the total mass of solids of the syrup, preferentially between 90 and 99.90%, for example, between 91 and 99.80%, or even between 92.50 and 99.70%, or even between 93 and 99.60%, or even between 93.50 and 99.50%, or even between 94 and 99.40%, or even between 94.50 and 99.20%, most preferentially between 95 and 99% and
between 0, 1 and 20% by weight of said starch relative to the total mass of solids of the syrup, preferentially between 0.1 and 10%, for example, between 0.20 and 9%, or even between 0.30 and 7.50%, or even between 0.40 and 7%, or even between 0.50 and 6.50%, or even between 0.60 and 6%, or even between 0.80 and 5.50%, most preferentially between 1 and 5%. Preferably, the weight ratio between the sweetening agent and the chemically unmodified pregelatinized starch ranges between 4 and 10,000, preferably between 10 and 1000, most preferentially between 20 and 100. The hard crystalline coating may also contain ingredients such as flavoring agents, artificial sweeteners, dispersants and emulsifiers, coloring agents, whitening agents, film-forming agents and binding agents. The contemplated flavoring agents comprise those commonly known in the art such as essential oils, synthetic flavorings or mixtures thereof, including, but not limited to, oils derived from plants and fruits such as citrus oils, fruit essences, peppermint oil, spearmint oil, other mint oils, clove oil, wintergreen oil, aniseed and the like. The flavoring agents also may be added to the coating syrup in an amount such that the coating contains approximately 0.2% to approximately 3.0% by weight of said flavoring agent relative to the total mass of solids of the syrup.

The flavoring agents may be added before, during and after applying the syrup on the cores. Once the coating has dried in order to form a hard surface, additional syrups may be added in order to produce a plurality of coatings or several hard coating layers.

Artificial or natural sweeteners, in particular high intensity sweeteners, contemplated for use in the coating comprise, but are not limited to, synthetic substances, saccharin, thaumatine, alitam, salts of saccharin, aspartame, sucralose and acesulfame K. The artificial sweetener may be added to the syrup coating in such an amount that the coating contains from approximately 0.01% to approximately 1.0% and typically from approximately 0.10% to approximately 0.5%, by weight of said artificial sweetener relative to the total mass of solids of the syrup and the same for the natural sweetening agent such as Stevia.

Whitening agents are often added to the sugar-coating syrup for the purpose of whitening and reducing stickiness. These may be sucrose esters or any other anti-adhesive compound. The sucrose ester may increase the whiteness or the rate of crystallization, for example.

The whitening agent may be added to the sugar-coating syrup in such an amount that said syrup contains approximately 0.05% to approximately 1.0%, and typically approximately 0.3% to approximately 0.6% by weight of said agent relative to the total mass of solids of the syrup.

Colorings may be added directly to the coating syrup in the form of a coloring or lacquer. Colorings may be mineral fillers that may be titanium dioxide and talc or organic components such as native starches, for example, rice starch. The coloring agents contemplated by the present invention comprise food-grade colorings. The present invention preferentially excludes titanium dioxide, or even any mineral filler, or even any additional coloring agent. These amounts will vary depending on the type of colorings. With respect to the mineral fillers, it is possible to use up to 5% by weight relative to the total mass of solids of the syrup. With respect to the organic components, it is possible to use up to 10% by weight relative to the total mass of solids of the syrup. According to one variant, the mixture comprises less than 3% by weight of native starch, for example, less than 1% or the mixture is even free of native starch.

There are several phases to be followed in order to produce a traditional sugar-coating. Traditional sugar-coating is carried out in a sugar-coating turbine that continuously rotates. This method runs over several repetitive steps, as described below.

Initialization of the Sugar-Coating

During this first phase, the aim is to start the crystallization phenomenon. Firstly, the centers need to be moistened with syrup composed of 60% to 80% of solids and water. The viscosity of the syrup is determinative and limits its solids. The syrup must be able to be homogeneously poured over the centers. Furthermore, if the syrup is too viscous, this would increase the risk of the centers sticking to one another or to the turbine.

The inserted syrup therefore must succeed in crystallizing and therefore in drying (if there is crystallization, the released water can evaporate). A bare hand verification is carried out in order to feel, using low center pressures in the hand, whether or not they are still moist. (This handling only occurs when the sugar-coating protocol is set up).

When inserting syrup, the other remaining risk is that of the centers sticking to one another or to the turbine. A verification will also be made in this respect by sampling handles of centers and if necessary by unsticking the maximum number of existing doubles, or by unsticking the centers from the surface of the turbine.

In general, the coating process is carried out in a rotary turbine. The centers to be coated or broken are placed in the rotary turbine in order to form a movable mass.

Enlargement

The aim is to apply the maximum possible amounts of syrup and therefore the least possible layers. Since the size of the products increases, the amount of syrup to be poured into the turbine needs to be gradually increased in order to homogeneously coat all the centers.

During this phase, one of the risks involves not succeeding in fully coating the syrup centers. The flat portions will easily overlap, while the corners or small edges may be more difficult to cover. In order to cover these edges and therefore to have uniform sugar-coating, the least viscous syrup possible needs to be used so that it can be inserted into the different gaps that may exist.

During the enlargement phase, a liquid flavoring can be introduced in order to enhance the taste of a sugar-coated product, such as a chewing gum.

During the enlargement, sticking will also be checked in order to avoid doubles that would risk, if not unstuck soon enough, breaking the created crystalline surface.

The cores to be coated are subjected to “turbining”, that is, a rotational movement in a sugar-coating turbine. This can assume an ordinary shape, that is, a tulip shape with a tilted axis of revolution or even a cylindrical shape with a horizontal axis. The cores, preferably decontaminated before or after they are introduced into the turbine, preferably have a spherical, cylindrical or oval shape in order to facilitate the coating operation but equally may well have a cushion shape.

Then, a rest step is necessary. During this step, the turbine continues to rotate and the previously poured syrup will disperse over the entire surface of the chewing gums.

As the enlargement progresses, the sugar-coating surface may be found to remain rough. However, a wax needs to be added at the end of the method in order to make the center glossy. This waxing phase is not possible if the surface area of the centers is rough because only certain parts of the product would gloss and this would yield poor rendering. To this end, a smoothing phase is essential after the enlargement.

Smoothing

During this phase, the surface of the chewing gum in question is rendered smooth. This step will be carried out by introducing small amounts of syrup into the turbine. The syrup, in small amounts, will flatten the surface of the chewing gums in question, the rest time for its part will be longer in order to allow the chewing gums to rub against one another and therefore to erode in order to smooth the surface thereof.

It will also be necessary to check that there are no doubles due to sticking.

Polishing

This last phase consists in giving the chewing gum sugar-coating in question a glossy appearance. Powdered wax will therefore be introduced (in very small amounts) in order to have a polished appearance.

When the wax has been properly distributed over the centers, the turbine and the drying will be stopped in order to leave the chewing gums to dry in the open air and to prevent them from colliding too much, which could damage them (damage or even break the sugar-coated layer).

When the sugar-coating is finished, a waiting step (depending on the syrup used) will be needed before packaging in order for the crystallization to finish and to have maximum crunchiness for the chewing gum in question (up to two days if drying in open air).

Finally, the drying step, which is optional but desirable, especially when the polyol is xylitol, follows. Drying can be carried out inside the sugar-coating turbine or in perforated containers by blowing dry and hot air or outside the latter, for example, by placing the cores coated with the semi-crystalline mixture in a cooking chamber. This step aims to evaporate the water present in the syrup and to allow more complete crystallization of the polyol. Instead of carrying out this step, it is also possible to allow the semi-crystalline coating to evolve naturally toward a crystalline state.

A person skilled in the art will know how to adjust the temperature of the air in order to prevent excessively hot air from deforming the centers.

Flavoring agents may be added before, during and after the syrup is applied on the centers. Once the coating has dried in order to form a hard surface, additional syrups may be added in order to produce a plurality of coatings or several hard coating layers.

The syrup to be applied to the centers has a temperature between 20 and 100° C., preferably between 40 and 80° C. throughout the coating process in order to prevent the polyol or the sugar from crystallizing in the tank or piping. The syrup can be mixed, sprayed, poured or added to the centers in any way known to a person skilled in the art.

In general, in order to obtain a plurality of layers, single layers of syrup are applied, allowing the layers to dry, then repeating the process. The amount of solids added by each coating step mainly depends on the concentration of the coating syrup. Any number of layers may be applied to the centers. Preferably, no more than approximately 75 layers are applied to the centers. As a general rule, approximately 30 to approximately 60 layers are applied. In all cases, the present invention contemplates applying a sufficient amount of syrup in order to yield a coated or edible chewing gum containing approximately 10% to approximately 65% of coating. Preferably, the final product will contain from approximately 20% to approximately 50% of coating.

The sugar-coating syrup is applied to the cores in the form of hot liquid, the sugar or the polyol will be left to crystallize, then the coating is dried in dry air. An amount of powder or mixture of powder may be added to some layers in order to either initiate the crystallization or to add whiteness, or to gain weight more quickly, or for any other reasons.

A flavor is applied with one, two, three or even four or more of these coating applications. Each time flavor is added, several unflavored coatings are applied to cover the flavor before applying the next layer of flavor. This reduces the volatilization of the flavoring during the coating process.

With respect to the water content, it is preferable, by virtue of the final drying, for it to be lowered to a value of less than 1.5%, preferably less than 1.0%, and more preferentially less than 0.5%.

A seeding step may be added if necessary depending on the syrup used, before drying in order to initiate the crystallization. Similarly, liquid flavorings may be added to the last sugar-coating cycles if desired. Finally, a final polishing/varnishing step may be carried out in order to have a final product with a glossy appearance.

As indicated above, the composition of the sugar-coating syrups may be different depending on the location of the sugar-coating layers within the hard crystalline coating (inner, intermediate or outer layers).

Preferably, during sugar-coating, the same syrup is used throughout the method, with said syrup being able to be diluted with solvent during the cycles.

Preferentially, the chemically unmodified pregelatinized starches are the only binding agents of the sugar-coating syrup.

Another subject matter of the invention relates to a sugar-coated confectionery product obtained by a method as described above.

A fourth subject matter of the invention relates to a dry pre-mixed sugar-coating composition comprising a mixture of at least one sweetening agent and at least one chemically unmodified pregelatinized starch, with said starch not having undergone chemical modifications, said composition comprising less than 1% by weight of gum arabic relative to the total weight, preferably with said composition being free of gum arabic.

Said starch therefore has not undergone chemical modifications such as oxidation or chemical grafting

Such a pre-mixed composition has many advantages: that of being ready to be used and therefore for this reason allowing considerable savings and therefore significant gains in productivity, that of being simple to use and to install industrially, that of allowing reproducibility of the methods over time, that of allowing the preparation of very high quality, non-sticky sugar-coated products and not significantly changing in appearance or texture over time.

Preferably, the pregelatinized starch that is used is obtained by pregelatinization, as described above.

Preferably, the composition comprises less than 1% by weight of gum arabic relative to the total dry weight of the coating or of the mixture, preferably comprising less than 0.5% by weight of gum arabic relative to the total dry weight of the coating or of the mixture, said coating or said mixture, more preferably, said coating or said mixture is free of gum arabic.

Preferably, the coating that is obtained or said composition thus prepared are free of polysorbate, or even of emulsifiers.

Preferably, the coating that is obtained or said composition is less than 1.5%, for example, less than 0.5% by weight of titanium dioxide relative to the total dry weight of said coating or said composition, preferably less than 0.1% by weight of titanium dioxide relative to the total dry weight of said coating or said composition, more preferably, said coating or said mixture is free of titanium dioxide (TiO₂).

Preferably, said composition comprises:
between 80 and 99.90% by weight of said sweetening agent relative to the total mass of solids of the composition, preferentially between 90 and 99.90%, for example, between 91 and 99.80%, or even between 92.50 and 99.70%, or even between 93 and 99.60%, or even between 93.50 and 99.50%, or even between 94 and 99.40%, or even between 94.50 and 99.20%, most preferentially between 95 and 99% and
between 0.1 and 20% by weight of said starch relative to the total mass of solids of the composition, preferentially between 0.1 and 10%, for example, between 0.20 and 9%, or even between 0.30 and 7.50%, or even between 0.40 and 7%, or even between 0.50 and 6.50%, or even between 0.60 and 6%, or even between 0.80 and 5.50%, most preferentially between 1 and 5%. Preferably, the mass ratio between the sweetening agent and the chemically unmodified starch is between 4 and 10,000, preferably between 10 and 1,000, most preferentially between 20 and 100. Preferably, the composition may comprise, in addition to ingredients such as flavoring agents, artificial sweeteners, dispersing and emulsifying agents, coloring agents, whitening agents, film-forming agents and binding agents, as described above.

Preferably, the chemically unmodified pregelatinized starch has a viscosity ranging from 0.001 to 0.30 Pa·s, advantageously from 0.02 to 0.25 Pa·s, preferentially from 0.04 to 0.20 Pa·s, measured according to a test B, with test B consisting in measuring the viscosity, determined at a frequency of s-1 and at 20° C., of an aqueous solution at 5% by mass of pregelatinized starch.

Preferably, the chemically unmodified pregelatinized starch is a pregelatinized native starch.

Preferably, the sweetening agent is a polyol.

Preferably, the polyol is selected from sorbitol, mannitol, maltitol, xylitol, isomalt, erythritol and lactitol or a mixture thereof, preferably maltitol or xylitol.

Preferably, the chemically unmodified pregelatinized starch is selected from pregelatinized, chemically unmodified pea starch, chemically unmodified pregelatinized corn starch or pregelatinized waxy corn starch.

Preferably, the sweetening agent is a sugar selected from sucrose and dextrose, galactose.

Thus, in the case of a sugar-free composition, the sweetening agent is especially a polyol that can be selected from sorbitol, mannitol, maltitol, xylitol, isomalt, erythritol and lactitol, preferentially maltitol, isomalt and xylitol, more preferentially maltitol, xylitol, most preferentially maltitol.

Moreover, a sweetening agent forming said mixture may be selected from at least one sugar or at least one polyol or a mixture thereof.

In the case of a composition with sugar, the sweetening agent especially can be a sugar selected from sucrose, dextrose, isomaltulose (palatinose), maltose and galactose, preferably, sucrose, dextrose or galactose, most preferentially sucrose.

Alternatively, in the case of a composition with sugar, the mixture may comprise at least two sweetening agents selected from at least one sugar and at least one polyol, said sugar being selected from sucrose, dextrose, isomaltulose (palatinose), maltose and galactose, preferably sucrose, dextrose or galactose and said polyol being selected from sorbitol, mannitol, maltitol, xylitol, isomalt, erythritol and lactitol, preferentially maltitol, isomalt and xylitol, more preferentially maltitol, xylitol, most preferentially maltitol.

Preferably, the average size d50 of the powder ranges from 10 to 1,000 μm, for example, between 100 and 800 μm.

Preferentially, the chemically unmodified pregelatinized starches are the only binding agents of the sugar-coating syrup.

Preferably, such a composition is suitable when preparing a sugar-coating syrup within the context of a method as described above.

Another subject matter of the invention relates to a sugar-coated confectionery product obtained by a method as described above.

### Measuring Method and Equipment

Viscosity

Viscosity of the Sugar-Coating Syrups

The viscosity measurement according to test A can be carried out on an Anton Paar MCR301 rheometer equipped with CC27 concentric cylinders. Shearing of 0 to 50 s-1 in 3 minutes (linear ramp) is applied at Peltier-regulated temperatures of 80, 70, 60, 50, 40, 30, 20° C.

Whiteness

The whiteness index was measured on a spectrophotometer marketed by Konica Minolta (CM-5) with the following conditions:
measurement mode: Reflection
aperture:/SCI (specular reflection included)
L*a*b CMC (color space)/WI ASTM E313-96 (color index)
10° (observer)/D65 (illuminant 1)/none (illuminant 2).

Hardness

The measurement of the hardness of the chewing gums is carried out at 20° C. using a 5966 INSTRON texturometer machine marketed by INSTRON, in accordance with the following protocol:

Measurement cell: 100 N

Geometry—cone punch (broken) with a base of 40 mm and a height of 38 mm.

Method—Traverse speed: 1.5 mm/min

Imposed deformation: 1.5 mm depression

Pre-load of 2.5 N to 5 mm/min

The chewing gum samples were approximately 21 mm long, 7 mm wide, 3 mm thick.

The force is recorded in newtons, and the value used is the maximum force, knowing that the evaluation stops when a 0.1 N drop is observed in the force measurement. The hardness of the chewing gum is characterized in the state cooled to 20° C.

The hardness thus measured corresponds to the force required for the initial break in the coating to be obtained.

Crunchiness

The crunchiness for its part corresponds to the number of breaks in the coating obtained for an imposed penetration of the punch that is used.

The measurement of the crunchiness of chewing gums is carried out at 20° C. using a 5966 INSTRON texturometer machine marketed by INSTRON, in accordance with the following protocol:

Measurement cell: 100 N

Geometry—Cone punch (broken) with a base of 40 mm and a height of 38 mm.

Method—Traverse speed: 1.5 mm/min

Imposed deformation: 1.5 mm depression

Pre-load of 2.5 N to 5 mm/min

Impact Resistance (“Chipping”)

50 sugar-coated products are left to free fall from a height of one meter. The percentage corresponding to the number of products having damaged corners relative to the 50 sugar-coated products is thus computed.

Color Uniformity

The uniformity of the color is evaluated by the operator by classifying it as follows:
−−: very poor
−: poor
0: fair
+: good
++: very good

Preparation of the Syrups

The analyzed syrups are obtained based on a mixture of a binding agent according to the invention or according to the prior art present at the rate indicated by dry weight relative to the total weight of solids of said syrup and/or a polyol present at the rate indicated by dry weight relative to the total weight of solids of said syrup in water as follows.

For the illustrative examples presented below, the following compounds were used:

Powder Polyols

Maltitol powder: Sweetpearl® P200 (Roquette®)

Maltitol powder: Sweetpearl® P35 (Roquette®)

Xylitol powder: Xylisorb® 300 (Roquette®)

Binders

Hard gum arabic: Quick Gum Type 8074RD—NOREVO

Unmodified pregelatinized waxy corn starch: Pregeflo® C100 (Roquette®)

Unmodified pregelatinized pea starch: Pregeflo® L100G (Roquette®)

Unmodified pregelatinized corn starch: Pregeflo® M (Roquette®)

Tapioca dextrin: CLEARGUM® TA 90 (Roquette®)

Modified octenyl succinate waxy corn starch: CLEARGUM® CO 03 (Roquette®)

Pregelatinized hydroxypropylated pea starch: LYCOAT® RS 780 (Roquette®)

Pea Maltodextrin: KLEPTOSE® LINECAPS (Roquette®)

Pectin: Genu® Pectin (CPKelco)

Substitute of commercial gum arabic (hydrocolloids): TicaPAN® 311 (TIC gums)

Liquid Maltitol

Non-crystallizable maltitol syrup with 73% of solids: Lycasin® HBC (Roquette®)

### EXAMPLES

### Example 1—Manufacture of Sugar-Coated Chewing Gums

Preparation of Maltitol-Based Sugar-Coating Syrups (for Sugar-Coating in an 8 kg Turbine)

Preparation of the Binder Solutions

Solution of Gum Arabic:

To prepare the gum arabic-based sugar-coating solution, a 40% solution of solids of gum arabic is produced by dispersing with high-speed stirring the gum arabic in water at room temperature and leaving it to stand for 12 hours in order to defoam the solution. This protocol prevents the gum arabic from degrading and staining.

Solution of the Other Binders:

To prepare the sugar-coating solution based on a binder other than gum arabic, a 20% solution of solids of binder is produced by placing the binder in water (except for pectin where the solution is 4% of solids). The solution is heated to the temperature indicated in Table 1 so as to dissolve the binder in the solution.

Preparation of the Polyol Solutions from Powdered Polyols

Maltitol Solutions

A maltitol solution is prepared by solubilizing a defined amount of maltitol powder P200 in order to obtain, after mixing with the aforementioned binder solutions, 70% of solids in the sugar-coating solution. The maltitol solution is maintained at 70° C.

Xylitol Solutions

A xylitol solution is prepared by solubilizing a defined amount of xylitol powder in order to obtain, after mixing with the aforementioned binder solutions, 75% of solids in the sugar-coating solution. The xylitol solution is maintained at 70° C.

Preparation of the Sugar-Coating Syrups

To prepare the sugar-coating syrups, the solutions are mixed so as to obtain the desired amount of binder. The amounts of binder relative to the total solids of the sugar-coating solution are indicated in Table A. With respect to the test with Lycasin HBC, the non-crystallizable maltitol syrup is added instead of the binder.

Maltitol-based sugar-coating syrups exhibit 70% of solids and those based on xylitol exhibit 75% of solids in the sugar-coating solution.

The sugar-coating syrups are mixed and maintained at 70° C. before use.

Viscosity

The viscosity properties of the various sugar-coating solutions (CP for comparative purposes and I for the invention) measured according to test A are listed in Table 1.

TABLE 1

| | | Binder amount | T | | | | | | | |
|---|---|---|---|---|---|---|---|---|---|---|
| | Binder | (% DM(Dry Matter)/Sugar- | ° C. binder | Sugar-coating viscosity (Pa · s) | | | | | | |
| Binder | type | coating solution total DM) | solution | 80° C. | 70° C. | 60° C. | 50° C. | 40° C. | 30° C. | 20° C. |
| Gum arabic | CP | 5% | 20 | 0.052 | 0.073 | 0.115 | 0.195 | 0.356 | 0.705 | 1.522 |
| CLEARGUM TA | CP | 5% | 60 | 0.02 | 0.028 | 0.042 | 0.066 | 0.112 | 0.202 | 0.384 |
| 90 | | | | | | | | | | |
| CLEARGUM | CP | 5% | 60 | 0.021 | 10.03 | 0.045 | 0.071 | 0.12 | 0.218 | 0.416 |
| CO03 | | | | | | | | | | |
| LYCOAT RS 780 | CP | 5% | 50 | 0.042 | 0.058 | 0.089 | 0.145 | 0.254 | 0.48 | 0.96 |
| KLEPTOSE | CP | 5% | 20 | 0.025 | 0.036 | 0.056 | 0.094 | 0.167 | 0.324 | 0.693 |
| LINECAPS | | | | | | | | | | |
| Lycasin HBC | CP | 10% | 20 | 0.018 | 0.026 | 0.04 | 0.065 | 0.112 | 0.209 | 0.41 |
| Genu Pectin Pan | CP | 1% | 20 | 0.1 | 0.14 | 0.22 | 0.35 | 0.6 | 0.88 | 1.38 |
| Ticapan 311 | CP | 4% | 80 | 0.038 | 0.057 | 0.088 | 0.146 | 0.257 | 0.478 | 0.919 |
| Pregeflo C100 | I | 4% | 95 | 0.418 | 0.505 | 0.634 | 0.83 | 1.15 | 1.75 | 2.99 |

Manufacture of Sugar-Coated Chewing Gum

Conventionally, sugar-coated chewing gums are manufactured by placing 8 kg of chewing gum centers in a Frogerais type manual copper sugar-coating turbine with a capacity of approximately 30 kg of centers. The turbine speed is approximately 18 revolutions per minute.

In the first sequence of the sugar-coating method, P35 maltitol powder is placed in the sugar-coating turbine. Throughout the method, the sugar-coating solution is applied on the centers and the sugar-coating conditions are listed in Tables 2 to 10 below according to the type of binder.

Gum Arabic

TABLE 2

| Sequence | 1 | 2 | 3 | 4 | 5 | 6 | | 7 | 8 | 9 | | | Polishing |
|---|---|---|---|---|---|---|---|---|---|---|---|---|---|
| Number of fillers | 5 | 3 | 3 | 4 | 2 | 3 | 2 | 2 | 7 | | 1 | 1 | |
| Amount of syrup per filler (ml) | 80 | 100 | 120 | 140 | 140 | 140 | 120 | 100 | 80 | | 20 | 10 | |
| % DM syrup | 70% | | | | | | | | 68% | 64% | | | |
| Rest time (min) | 0.5 | 1 | 1.5 | 2 | 0.5 | 2 | 2 | 0.5 | 1.5/2 | | 2 | 1.5 | |
| Amount of P35 per filler (g) | 75 | / | / | / | / | / | / | / | / | | / | / | |
| Amount of flavor per filler (g) | / | / | / | / | 9.5 | / | / | 9.5 | / | | / | / | |
| Flavor or filler rest time (min) | 1 | / | / | / | 1.5 | / | / | 1.5 | / | | / | / | |
| Drying time (min) | 3.5/4.5 | 3.5/4 | 2.5/3.5 | 3 | 3 | 2.5 | 12.5 | 2 | 2 | | 1 | 0 | |
| Air temperature (° C.) | 20 | 20 | 30 | 30 | 30 | 30 | 30 | 30 | 20 | | 20 | 20 | |
| % sugar-coating | 11.1 | / | 17.1 | 20.8 | / | / | 25.9 | / | 29.5 | 29.2 | / | / | 29.2 |

### CLEARGUM TA 90

TABLE 3

| Sequence | 1 | 2 | 3 | 4 | 5 | 6 | 7 | 8 | | 9 | | | Polishing |
|---|---|---|---|---|---|---|---|---|---|---|---|---|---|
| Number of fillers | 5 | 3 | 5 | 4 | 2 | 4 | 2 | 4 | 6 | 2 | 2 | 1 | |
| Amount of syrup per filler (ml) | 80 | 100 | 120 | 140 | 140 | 140 | 100 | 90 | 80 | 50 | 20 | 10 | |
| % DM syrup | 70% | | | | | | | 68% | | 65% | | | |
| Rest time (min) | 0.5 | 1 | 1.5 | 1.5 | 0.5 | 2 | 0.5 | 1.5 | 1.5 | 5 | 2 | 1.5 | |
| Amount of P35 per filler (g) | 75 | / | / | / | / | / | / | / | / | / | / | / | |
| Amount of flavor per filler (g) | / | / | / | / | 9.5 | / | 9.5 | / | / | / | / | / | |
| Flavor or filler rest time (min) | 1 | / | / | / | 1.5 | / | 1.5 | / | / | / | / | / | |
| Drying time (min) | 4.5/6 | 6/5/4 | 3/2.5 | 3 | 3/2.5 | 3/2.5 | 3 | 1.5/2 | 2 | 1 | 1 | 0 | |
| Air temperature (° C.) | 20 | 30 | 30 | 30 | 30 | 30 | 30 | 20 | 20 | 20 | 20 | 20 | |
| % sugar-coating | 8.7 | 10.7 | 15.6 | 20.2 | 21.3 | 25.2 | 25.3 | / | 29.2 | / | / | / | 29.2 |

CLEARGUM 0003

TABLE 4

| Sequence | 1 | 2 | 3 | 4 | 5 | 6 | | 7 | 8 | | 9 | | | Polishing |
|---|---|---|---|---|---|---|---|---|---|---|---|---|---|---|
| Number of fillers | 5 | 3 | 5 | 4 | 2 | 5 | 2 | 2 | 3 | 4 | 2 | 1 | 1 | |
| Amount of syrup per filler (ml) | 80 | 100 | 120 | 140 | 140 | 140 | 120 | 100 | 90 | 80 | 25 | 20 | 10 | |
| % DM syrup | 70% | | | | | | | | 68% | | 64% | | | |
| Rest time (min) | 0.5 | 1 | 1.5 | 1.5 | 0.5 | 2 | 2 | 0.5 | 3/2.5 | 2 | 2.5 | 2 | 2 | |
| Amount of P35 per filler (g) | 75 | / | / | / | / | / | / | / | / | / | / | / | / | |
| Amount of flavor per filler (g) | / | / | / | / | 9.5 | / | / | 9.5 | / | / | / | / | / | |
| Flavor or filler rest time (min) | 1 | / | / | / | 1.5 | / | / | 1.5 | / | / | / | / | / | |
| Drying time (min) | 5/6 | 6/7 | 3.5 | 3.5 | 4 | 3 | 3 | 2 | 3/4 | 3/4 | 1 | 1 | 0 | |
| Air temperature (° C.) | 20 | 20 | 30 | 30 | 30 | 30 | 30 | 30 | 20 | 20 | 20 | 20 | 20 | |
| % sugar-coating | 9.2 | 11.1 | / | 19.5 | / | 24.3 | 24.4 | / | / | 29.5 | / | / | / | 29.5 |

LYCOAT RS 780

TABLE 5

| Sequence | 1 | 2 | 3 | 4 | 5 | 6 | | 7 | 8 | | 9 | | | Polishing |
|---|---|---|---|---|---|---|---|---|---|---|---|---|---|---|
| Number of fillers | 5 | 3 | 5 | 4 | 2 | 6 | 1 | 2 | 3 | 5 | 2 | 1 | 1 | |
| Amount of syrup per filler (ml) | 80 | 100 | 120 | 140 | 140 | 140 | 120 | 100 | 90 | 80 | 25 | 20 | 10 | |
| % DM syrup | 70% | | | | | | | | 67% | | 64% | | | |
| Rest time (min) | 0.5 | 1 | 1.5 | 1.5/2 | 0.5 | 2.25 | 2.75 | 0.5 | 2.5 | 2 | 2.5 | 2.5 | 1.5 | |
| Amount of P35 per filler (g) | 75 | / | / | / | / | / | / | / | / | / | / | / | / | |
| Amount of flavor per filler (g) | / | / | / | / | 9.5 | / | / | 9.5 | / | / | / | / | / | |
| Flavor or filler rest time (min) | 1 | / | / | / | 1.5 | / | / | 1.5 | / | / | / | / | / | |
| Drying time (min) | 5/6 | 6/6/4 | 3/2.5 | 3.5 | 3.5 | 3.5 | 4 | 3 | 2.5 | 3/2 | 1 | 1 | 0 | |
| Air temperature (° C.) | 20 | 30 | 30 | 30 | 30 | 30 | 30 | 30 | 20 | 20 | 20 | 20 | 20 | |
| % sugar-coating | 7.2 | 10.7 | / | 19.2 | / | 26.1 | / | 27.1 | / | 29.4 | / | / | / | 29.4 |

KLEPTOSE LINECAPS

TABLE 6

| Sequence | 1 | 2 | 3 | 4 | 5 | 6 | 7 | 8 | | 9 | | | Polishing |
|---|---|---|---|---|---|---|---|---|---|---|---|---|---|
| Number of | 5 | 3 | 5 | 4 | 2 | 5 | 2 | 4 | 3 | 2 | 1 | 1 | |
| fillers | | | | | | | | | | | | | |
| Amount of | 80 | 100 | 120 | 140 | 140 | 140 | 100 | 80 | 90 | 25 | 20 | 10 | |
| syrup per filler | | | | | | | | | | | | | |
| (ml) | | | | | | | | | | | | | |
| % DM syrup | 70% | | | | | | | 67% | | 65% | | | |
| Rest time (min) | 0.5 | 1 | 1.25 | 1.5 | 0.5 | 1.5 | 0.5 | 1.5 | 1.5 | 2.5 | 2 | 2 | |
| Amount of P35 | 75 | / | / | / | / | / | / | / | / | / | / | / | |
| per filler (g) | | | | | | | | | | | | | |
| Amount of | / | / | / | / | 9.5 | / | 9.5 | / | / | / | / | / | |
| flavor per filler | | | | | | | | | | | | | |
| (g) | | | | | | | | | | | | | |
| Flavor or filler | 1 | / | / | / | 1 | / | 1.5 | / | / | / | / | / | |
| rest time (min) | | | | | | | | | | | | | |
| Drying time | 4.5/6 | 6/5 | 3 | 3 | 3 | 2.5 | 3 | 1.5 | 1.5 | 1 | 1 | 0 | |
| (min) | | | | | | | | | | | | | |
| Air temperature | 20 | 30 | 30 | 30 | 30 | 30 | 30 | 20 | 20 | 20 | 20 | 20 | |
| (° C.) | | | | | | | | | | | | | |
| % sugar-coating | 9.5 | 12.0 | 15.9 | 19.4 | 20.6 | 25.6 | 26.9 | / | 29.8 | / | / | / | 30.4 |

Genu Pectin Pan

TABLE 7

| Sequence | 1 | 2 | 3 | 4 | 5 | 6 | 7 | 8 | | 9 | | | Polishing |
|---|---|---|---|---|---|---|---|---|---|---|---|---|---|
| Number of | 5 | 3 | 5 | 4 | 2 | 4 | 2 | 5 | 7 | 2 | 1 | 1 | |
| fillers | | | | | | | | | | | | | |
| Amount of | 80 | 100 | 120 | 140 | 140 | 150 | 100 | 90 | 80 | 25 | 20 | 10 | |
| syrup per | | | | | | | | | | | | | |
| filler (ml) | | | | | | | | | | | | | |
| % DM syrup | 70% | | | | | | | | | | | | |
| Rest time | 0.5 | 1 | 1.5 | 1.5 | 0.5 | 2.5 | 0.5 | 2/2.5 | 1.5 | 3.5/3 | 2.5 | 1.5 | |
| (min) | | | | | | | | | | | | | |
| Amount of | 75 | / | / | / | / | / | / | / | / | / | / | / | |
| P35 per filler | | | | | | | | | | | | | |
| (g) | | | | | | | | | | | | | |
| Amount of flavor per | / | / | / | / | 9.5 | / | 9.5 | / | / | / | / | / | |
| filler (g) | | | | | | | | | | | | | |
| Flavor or | 1 | / | / | / | 1.5 | / | 1.5 | / | / | / | / | / | |
| filler rest | | | | | | | | | | | | | |
| time (min) | | | | | | | | | | | | | |
| Drying time | 5 | 5 | 3 | 3.5 | 3.5 | 2.5/3 | 4/3.5 | 2/3 | 3.5 | 1 | 1 | 0 | |
| (min) | | | | | | | | | | | | | |
| Air | 20 | 30 | 30 | 30 | 30 | 30 | 30 | 20 | 20 | 20 | 20 | 20 | |
| temperature | | | | | | | | | | | | | |
| (° C.) | | | | | | | | | | | | | |
| % sugar- | 9.2 | 10.6 | 15.6 | 19.4 | 21.1 | 24.4 | 25.0 | / | 29.3 | / | / | / | 29.3 |
| coating | | | | | | | | | | | | | |

Lycasin HBC

TABLE 8

| Sequence | 1 | 2 | 3 | 4 | 5 | 6 | 7 | 8 | 9 | | | Polishing |
|---|---|---|---|---|---|---|---|---|---|---|---|---|
| Number of | 5 | 5 | 5 | 5 | 2 | 4 | 2 | 7 | 2 | 1 | 1 | |
| fillers | | | | | | | | | | | | |
| Amount of | 80 | 100 | 120 | 140 | 130 | 140 | 120 | 80 | 25 | 20 | 10 | |
| syrup per filler | | | | | | | | | | | | |
| (ml) | | | | | | | | | | | | |
| % DM syrup | 70% | | | | | | | | 66% | | | |
| Rest time (min) | 0.5 | 1 | 1 | 1 | 0.5 | 1.5 | 0.5 | 1.5/1 | 3.5/3 | 2.5 | 2 | |
| Amount of P35 | 75 | / | / | / | / | / | / | / | / | / | / | |
| per filler (g) | | | | | | | | | | | | |
| Amount of | / | / | / | / | 9.5 | / | 9.5 | / | / | / | / | |
| flavor per filler | | | | | | | | | | | | |
| (g) | | | | | | | | | | | | |
| Flavor or filler | 1 | / | / | / | 1.5 | / | 1.5 | / | / | / | / | |
| rest time (min) | | | | | | | | | | | | |
| Drying time | 5 | 6/2.5 | 2.5 | 2.5 | 2.5/2 | 2 | 2.5 | 1.5/2 | 1 | 1 | 0 | |
| (min) | | | | | | | | | | | | |
| Air temperature | 20 | 30 | 30 | 30 | 30 | 30 | 30 | 20 | 20 | 20 | 20 | |
| (° C.) | | | | | | | | | | | | |
| % sugar- | 8.6 | 12.7 | 14.9 | 21.5 | 22.2 | 25.5 | 27.5 | 29.8 | / | / | / | 30.5 |
| coating | | | | | | | | | | | | |

Ticapan 311

TABLE 9

| Sequence | 1 | 2 | 3 | 4 | 5 | 6 | | 7 | 8 | 9 | | | Polishing |
|---|---|---|---|---|---|---|---|---|---|---|---|---|---|
| Number of | 5 | 3 | 5 | 5 | 2 | 4 | 2 | 2 | 7 | 2 | 1 | 1 | |
| fillers | | | | | | | | | | | | | |
| Amount of | 80 | 100 | 120 | 140 | 140 | 140 | 120 | 100 | 80 | 25 | 20 | 10 | |
| syrup per filler | | | | | | | | | | | | | |
| (ml) | | | | | | | | | | | | | |
| % DM syrup | 70% | | | | | | | | 68% | 65% | | | |
| Rest time (min) | 0.5 | 1 | 1.5 | 1.5 | 0.5 | 2 | 1.5 | 0.5 | 1.75 | 3 | 2.5 | 1.5 | |
| Amount of P35 | 75 | / | / | / | / | / | / | / | / | / | / | / | |
| per filler (g) | | | | | | | | | | | | | |
| Amount of flavor per filler | / | / | / | / | 9.5 | / | / | 9.5 | / | / | / | / | |
| (g) | | | | | | | | | | | | | |
| Flavor or filler | 1 | / | / | / | 1 | / | / | 1.5 | / | / | / | / | |
| rest time (min) | | | | | | | | | | | | | |
| Drying time | 5/3 | 4 | 4/2.5 | 3 | 3 | 2.5 | 3.5 | 3/2.5 | 1.75 | 1 | 1 | 0 | |
| (min) | | | | | | | | | | | | | |
| Air temperature | 20 | 20 | 30 | 30 | 30 | 30 | 30 | 30 | 20 | 20 | 20 | 20 | |
| (° C.) | | | | | | | | | | | | | |
| % sugar- | 9.1 | / | 15.9 | 19.8 | / | 25.2 | 26.1 | / | 29.9 | / | / | / | 29.9 |
| coating | | | | | | | | | | | | | |

Pregeflo C100

TABLE 10

| Sequence | 1 | 2 | 3 | 4 | 5 | 6 | 7 | 8 | | 9 | | | Polishing |
|---|---|---|---|---|---|---|---|---|---|---|---|---|---|
| Number of | 5 | 3 | 5 | 6 | 2 | 4 | 2 | 5 | 7 | 1 | 2 | 1 | |
| fillers | | | | | | | | | | | | | |
| Amount of | 80 | 100 | 120 | 140 | 140 | 160 | 100 | 90 | 80 | | 20 | 10 | |
| syrup per filler | | | | | | | | | | | | | |
| (ml) | | | | | | | | | | | | | |
| % DM syrup | 70% | | | | | | 66% | 63% | | | | | |
| Rest time (min) | 0.5 | 1 | 1.5 | 1.5 | 0.5 | 2.5 | 0.5 | 2.5/2 | 1.5 | 3 | 2.5 | 2 | |
| Amount of P35 | 75 | / | / | / | / | / | / | / | / | / | / | / | |
| per filler (g) | | | | | | | | | | | | | |
| Amount of | / | / | / | / | 9.5 | / | 9.5 | / | / | / | / | / | |
| flavor per filler | | | | | | | | | | | | | |
| (g) | | | | | | | | | | | | | |
| Flavor or filler | 1 | / | / | / | 3 | / | 2 | / | / | / | / | / | |
| rest time (min) | | | | | | | | | | | | | |
| Drying time | 5/6.5 | 15/3 | 3/3.5 | 4/5 | 3 | 3 | 2.5 | 2.5/4 | 4/5 | 1 | 1 | 0 | |
| (min) | | | | | | | | | | | | | |
| Air temperature | 20 | 30 | 30 | 30 | 30 | 30 | 30 | 20 | 20 | 20 | 20 | 20 | |
| (° C.) | | | | | | | | | | | | | |
| % sugar- | 7.6 | 9.9 | 13.9 | 20.7 | 21.2 | 24.9 | 25.6 | 27.5 | 29.3 | / | / | / | 29.3 |
| coating | | | | | | | | | | | | | |

The sugar-coated chewing gums are recovered and analyzed according to the experimental methods described above.

The chewing gum properties of hardness, crunchiness and whiteness are listed in Table 11 below.

TABLE 11

| | | Crunchiness | | |
|---|---|---|---|---|
| | Hardness | (number | Whiteness | Color |
| | (N) | of peaks) | index | uniformity |
| CLEARGUM TA 90 | 9.2 | 15 | 52.3 | − |
| LYCASIN HBC | 8.8 | 10 | 71.9 | + |
| CLEARGUM CO03 | 8.1 | 21 | 66.9 | −− |
| KLEPTOSE | 7.8 | 18 | 65.0 | 0 |
| LINECAPS | | | | |
| LAB4118 | | | | |
| GENU PECTIN | 7.1 | 16 | 69.3 | + |
| PAN | | | | |
| TICAPAN 311 | 7.3 | 26 | 71.3 | + |
| LYCOAT RS 780 | 7.0 | 26 | 71.5 | 0 |
| GUM ARABIC | 10.6 | 28 | 48.7 | + |
| PREGEFLO C100 | 11.3 | 34 | 74.2 | + |

Chewing gums with a coating that includes chemically unmodified pregelatinized starch (PREGEFLO C100) exhibit the best results in terms of hardness, crunchiness, whiteness index and color uniformity.

Furthermore, quite surprisingly, it has been found that the whiteness index of the hard crystalline coating of chewing gums based on the chemically unmodified pregelatinized starch according to the invention is equivalent to that of the hard crystalline coating of chewing gums based on gum arabic and on titanium dioxide, which coating for its part has a whiteness index of 74.3. It is well known that titanium dioxide is intensively used in the coatings of sugar-coated products in order to make said coating white and, at the same time, to conceal visual defects originating from other constituents, such as gum arabic.

### Example 2—Manufacture of Sugar-Coated Chewing Gums from Pre-Mixtures

Preparation of the Polyol and Pregelatinized Starch Pre-Mixtures

To prepare the pre-mixtures, or “pre-mixed compositions”, a mixer is used to dry and cold mix the P200 maltitol powder with the pregelatinized starch in the proportions indicated in the above Table.

Preparation of the Sugar-Coating Syrups

Except for the sugar-coating solution using gum arabic, which is manufactured as in example 1, the previously described pre-mixtures are used to prepare the sugar-coating solutions. Indeed, for gum arabic, which degrades, then preferably pre-mixing is not carried out so as to avoid degrading the gum arabic and the solution of gum arabic is added at the last moment at 70° C.

The sugar-coating solution comprising the unmodified pregelatinized starches is prepared by solubilizing the pre-mixtures in water at 85° C. and by maintaining the temperature.

The sugar-coating solutions have 70% of solids and are maintained at 70° C. before use.

The viscosity properties of the various sugar-coating solutions are listed in Table 12 below.

TABLE 12

| | | Binder amount | | | | | | | |
|---|---|---|---|---|---|---|---|---|---|
| | | (% DM(Dry | | | | | | | |
| | | Matter)/Sugar- | | | | | | | |
| | | coating solution | Sugar-coating solution viscosity (Pa · s) | | | | | | |
| Reference | Binder type | total DM) | 80° C. | 70° C. | 60° C. | 50° C. | 40° C. | 30° C. | 20° C. |
| Gum arabic | comparative | 5% | 0.052 | 0.073 | 0.115 | 0.195 | 0.356 | 0.705 | 1.522 |
| Pregeflo | Invention | 4% | 0.23 | 0.27 | 0.34 | 0.45 | 0.62 | 0.92 | 1.46 |
| C100 | | | | | | | | | |
| Pregeflo | invention | 3% | 0.04 | 0.043 | 0.056 | 0.08 | 0.13 | 0.22 | 0.41 |
| L100 G | | | | | | | | | |
| Pregeflo M | invention | 3% | 0.083 | 0.107 | 0.144 | 0.2 | 0.3 | 0.47 | 0.8 |

Manufacture of the Sugar-Coated Chewing Gums

The chewing gums are prepared in a similar manner to that described in example 1, that is, the protocol established for the unmodified pregelatinized pea and corn starches remains similar to that used for waxy corn.

The sugar-coated chewing gums are recovered and analyzed according to the experimental methods described above.

The chewing gum properties of hardness, crunchiness and whiteness are listed in Table 13 below.

TABLE 13

| | | Crunchiness | | |
|---|---|---|---|---|
| | Hardness | (number | Whiteness | Color |
| | (N) | of peaks) | index | uniformity |
| Gum arabic | 10.6 | 28 | 48.7 | + |
| Pregeflo C100 | 11.3 | 34 | 74.2 | + |
| Pregeflo L100 G | 11.3 | 50 | 76.1 | ++ |
| Pregeflo M | 11.2 | 47 | 74.5 | ++ |

As in the case of chewing gums, which when manufactured do not involve a sugar-coating syrup prepared from a pre-mixed composition, the chewing gums based on unmodified pregelatinized starch (PREGEFLO C100, PREGEFLO L100 G, PREGEFLO M) exhibit the best results in terms of hardness, crunchiness, whiteness index and color uniformity.

### Example 3—Manufacture of Sugar-Coated Chewing Gums from Pre-Mixtures on the Pilot Scale

Preparation of the sugar-coating syrups

Maltitol-based sugar-coating syrups are manufactured in a similar manner to that of example 2.

Xylitol-based sugar-coating solutions are manufactured in a similar manner to that of example 2, except for the following differences:
with regard to the test with the pregelatinized unmodified corn starch, pre-mixing of xylitol and pregelatinized starch is carried out in a similar manner to example 2, with the powder xylitol replacing the maltitol powder
the dry matters of the xylitol-based sugar-coating solutions exhibit a solids content of 75%, instead of 70% for those based on maltitol.

The sugar-coating solutions are mixed and maintained at 75° C. before use.

Manufacture of the Sugar-Coated Chewing Gums

50 kg of chewing gum centers is placed in a DRIAM DRIACOATER 1200 type automatic turbine. The sugar-coating solutions are applied to the centers according to the conditions shown in Tables 14 and 15 below. For xylitol sugar-coating, xylitol is not added in powder form during the method.

Maltitol Sugar-Coating

TABLE 14

| Sequence | 1 | 2 | 3 | 4 | 5 | 6 | | 7 | 8 | | 9 | | Polishing |
|---|---|---|---|---|---|---|---|---|---|---|---|---|---|
| Number of | 5 | 5 | 5 | 4 | 2 | 3 | 1 | 2 | 3 | 9 | 3 | 2 | |
| fillers | | | | | | | | | | | | | |
| Amount of | 0.5 | 0.6 | 0.7 | 0.8 | 0.8 | 0.9 | 1 | 0.6 | 0.7 | 0.6 | 0.2 | 0.1 | |
| syrup per filler | | | | | | | | | | | | | |
| (ml) | | | | | | | | | | | | | |
| % DM syrup | 70 | | | | | | | | 68 | 65 | | | |
| Rest time | 0.5 | 1 | 1.5 | 1.5 | 0.5 | 2 | 2 | 0.5 | 3.5 | 5 | 4/5 | 4 | |
| (min) | | | | | | | | | | | | | |
| Amount of | 0.4 | / | / | / | / | / | / | / | / | / | / | / | |
| P35 per filler | | | | | | | | | | | | | |
| (g) | | | | | | | | | | | | | |
| Amount of | / | / | / | / | 100 | / | / | 100 | / | / | / | / | |
| flavor per filler | | | | | | | | | | | | | |
| (g) | | | | | | | | | | | | | |
| Flavor or filler | 1 | / | / | / | 1/1.5 | / | / | 1.5/2 | / | / | / | / | |
| rest time (min) | | | | | | | | | | | | | |
| Drying time | 4/2.5 | 3.5 | 3.5 | 4/3.5 | 3.2 | 3.2 | 4 | 2.2/1.5 | 1.5 | 1/1.5 | 0.6 | 0.3/0 | |
| (min) | | | | | | | | | | | | | |
| Air | 25 | 28 | 28 | 30 | 30 | 32 | | 28 | 25 | | 25 | | |
| temperature | | | | | | | | | | | | | |
| (° C.) | | | | | | | | | | | | | |
| Speed (rpm) | 11 | 11 | 11 | 9 | 9 | 9 | | 9 | 10 | | 9 | | |
| % sugar- | 7.2 | 11.3 | 16.8 | 20.2 | 22.7 | 25.7 | | 33.0 | / | / | / | / | 34.0 |
| coating | | | | | | | | | | | | | |

Xylitol Sugar-Coating

TABLE 15

| Sequence | 1 | 2 | 3 | 4 | | 5 | 6 | | 7 | 8 | | 9 | | Polishing |
|---|---|---|---|---|---|---|---|---|---|---|---|---|---|---|
| Number of fillers | 5 | 5 | 4 | 5 | 8 | 2 | 3 | 4 | 2 | 4 | 2 | 2 | 1 | |
| Amount of syrup per filler (ml) | 0.3 | 0.4 | 0.5 | 0.6 | 0.5 | 0.5 | 0.6 | 0.6 | 0.6 | 0.4 | 0.4 | 0.2 | 0.1 | |
| % DM syrup | 69 | | | | | | | | | | | | | |
| Rest time (min) | 0.3 | 0.4 | 0.5 | 0.5 | 0.5 | 0.5 | 0.8 | 0.5 | 0.5 | 0.6 | 0.4 | 3.5 | 3.5 | |
| Amount of flavor per filler (g) | / | / | / | / | / | 100 | / | / | 100 | / | / | / | / | |
| Flavor or filler rest time (min) | / | / | / | / | / | 0.5 | / | / | 1 | / | / | / | / | |
| Drying time (min) | 2/1.5 | 2 | 2/1.5 | 1.7 | 1.7 | 2 | 1.5 | 1.5 | 2 | 1.2 | 1.5 | 0.5 | 0 | |

| Air temperature (° C.) | 22 | 22 | 22 | 22 | | 22 | 24 | 24 | 22 | 22 |
|---|---|---|---|---|---|---|---|---|---|---|
| Speed (rpm) | 10 | 10 | 10 | 10 | 11 | 10 | 10 | 10 | 10 | 10 |

| | | | | | | | | | | | | |
|---|---|---|---|---|---|---|---|---|---|---|---|---|
| % sugar-coating | 2.0 | 6.2 | 11.1 | 20.9 | 22.2 | 26.6 | 27.6 | / | 30.3 | / | / | 30.7 |

Table 16 below lists the results obtained on the pilot scale:

TABLE 16

| | | | Sugar- | Binder amount | | | | |
|---|---|---|---|---|---|---|---|---|
| | | | coating | (% DM(Dry | | | | |
| | | | solution | Matter)/Sugar- | | Crunchiness | | |
| | | | viscosity | coating solution | Hardness | (number of | Whiteness | Color |
| Polyol | Binder | Test type | (20° C.) | total DM) | (N) | peaks) | index | uniformity |
| Maltitol | Gum | comparative | 1.522 | 5% | 10.1 | | 51.4 | + |
| | arabic | | | | | | | |
| Maltitol | Pregeflo C100 | Invention | 1.46 | 4% | 15.8 | 32 | 83.5 | + |
| Xylitol | Pregeflo C100 | invention | 1.3 | 14% | 10.6 | 43 | 50.8 | + |

Impact Resistance

The resistance of the hard crystalline coating of chewing gums obtained by sugar-coating from a syrup based on maltitol and another binder, (70% by weight of solids relative to the total weight of the syrup) was measured.

This resistance results in the percentage of broken corners listed in Table 17.

TABLE 17

| | Broken Corners (%) |
|---|---|
| GUM ARABIC- 5% | 12.5% |
| PREGEFLOO C100 - 4% | 12.5% |
| TicaPan 311 - 5% | 18.0% |
| Genu Pectin Pan - 1% | 32.0% |

The resistance of the hard crystalline coating of chewing gums based on the chemically unmodified pregelatinized starch according to the invention is equivalent to that of the hard crystalline coating of chewing gums based on gum arabic. The coatings based on TicaPan 311 and Genu Pectin Pan are more brittle.

The invention is not limited to examples 1 to 3 described above, which are provided solely by way of example, but it encompasses all the variants that a person skilled in the art could contemplate within the scope of the sought after protection.

### Example 4—Influence of the Amounts of Pregelatinized Starch on the Properties of the Sugar-Coated Products that are Obtained

The protocol used in this test is similar to that of example 1: it differs in terms of the amount of PREGEFLO C100 (0%, 1% or 2% instead of 4% by dry weight of the sugar-coating solution).

The chewing gums thus obtained are blind tasted by three people and are scored from 1 to 10 for the crunchiness, the duration of the crunchiness and the noise in the mouth when the chewing gum is chewed. The hardness measured by the texturometer and the whiteness index are also measured.

Table 18 below lists the averages that are obtained:

TABLE 18

| | | Crunchi- | | White- | Hard- |
|---|---|---|---|---|---|
| | Crunchi- | ness | Noise in | ness | ness |
| Binder | ness | duration | mouth | index | (N) |
| No binder | 4 | 1 | 1 | 81.2 | 11.2 |
| 1% Pregeflo C100 | 7 | 5 | 5 | 74.7 | 15.2 |
| 2% Pregeflo C100 | 6 | 4 | 4 | 77.2 | 15.8 |

It has been found that the chewing gums with a sugar-coated layer that is free of pregelatinized starch have a surface that is sticky and more fragile than those of chewing gums comprising pregelatinized starch. The low crunchiness of this chewing gum disappears immediately when chewing.

The chewing gums comprising 1% of pregelatinized starch in the sugar-coating solution exhibit crunchiness similar to those comprising 2%.

The whiteness of the chewing gums is improved when the sugar-coating solution comprises more pregelatinized starch.

1. Use of a mixture of at least one sweetening agent and at least one chemically unmodified pregelatinized starch to improve the crunchiness of the hard crystalline coating of a sugar-coated product, with said starch not having undergone chemical modifications,
said coating and said mixture comprising less than 1% by weight of gum arabic relative to the total dry weight of the coating or of the mixture, preferably said coating or said mixture being free of gum arabic, and wherein said mixture comprises:
between 80 and 99.90% by weight of said sweetening agent relative to the total mass of solids of the mixture, preferentially between 90 and 99.90% and
between 0.1 and 20% by weight of said starch relative to the total mass of solids of the mixture, preferentially between 0.1 and 10%.

2. The use according to claim 1, wherein said mixture comprises:
between 95 and 99% by weight of said sweetening agent relative to the total mass of solids of the mixture,
between 1 and 5% by weight of said starch relative to the total mass of solids of the mixture.

3. The use according to claim 1, wherein the chemically unmodified pregelatinized starch is a pregelatinized native starch having undergone only pregelatinization treatment, preferably said pregelatinized native starch is selected from pregelatinized native pea starch, pregelatinized native corn starch or pregelatinized native waxy starch.

4. The use according to claim 1, wherein the sweetening agent is a polyol, preferably the polyol is selected from sorbitol, mannitol, maltitol, xylitol, isomalt, erythritol and lactitol or a mixture thereof, preferably maltitol or xylitol.

5. A sugar-coated confectionery product including a hard crystalline coating comprising a mixture of at least one sweetening agent and at least one chemically unmodified pregelatinized starch, with said starch not having undergone chemical modifications,
said coating and said mixture comprising less than 1% by weight of gum arabic relative to the total dry weight of the coating or of the mixture, preferably said coating or said mixture being free of gum arabic,
and wherein said mixture comprises:
between 80 and 99.90% by weight of said sweetening agent relative to the total mass of solids of the mixture, preferentially between 90 and 99.90% and
between 0.1 and 20% by weight of said starch relative to the total mass of solids of the mixture, preferentially between 0.1 and 10%.

6. The sugar-coated confectionery product according to claim 5, wherein said mixture comprises:
between 95 and 99% by weight of said sweetening agent relative to the total mass of solids of the mixture,
between 1 and 5% by weight of said starch relative to the total mass of solids of the mixture.

7. The sugar-coated confectionery product according to claim 5, wherein it is a chewing gum.

8. The sugar-coated confectionery product according to claim 5, wherein the chemically unmodified pregelatinized starch is a native starch, preferably said pregelatinized native starch is selected from chemically unmodified pregelatinized pea starch, chemically unmodified pregelatinized native corn starch or chemically unmodified native waxy corn starch.

9. The sugar-coated confectionery product according to claim 5, wherein the sweetening agent is a polyol, preferably the polyol is selected from sorbitol, mannitol, maltitol, xylitol, isomalt, erythritol and lactitol or a mixture thereof, preferably maltitol or xylitol.

10. A method for producing a hard crystalline coating around a core by hard sugar-coating, the method comprising the following steps:
preparing a sugar-coating syrup by mixing at least one sweetening agent and at least one chemically unmodified pregelatinized starch with a solvent,
creating a crystalline coating on the surface of the core by at least one application of said sugar-coating syrup;
with said starch not having undergone chemical modifications,
said coating and said syrup thus prepared comprising less than 1% by weight of gum arabic relative to the total dry weight of the coating or to the total weight of the syrup, preferably said coating or said syrup thus prepared being free of gum arabic,
and wherein said coating and said syrup comprise:
between 80 and 99.90% by weight of said sweetening agent relative to the total mass of solids of the mixture, preferentially between 90 and 99.90% and
between 0.1 and 20% by weight of said starch relative to the total mass of solids of the mixture, preferentially between 0.1 and 10%.

11. The method according to claim 10, wherein said mixture comprises:
between 95 and 99% by weight of said sweetening agent relative to the total mass of solids of the mixture,
between 1 and 5% by weight of said starch relative to the total mass of solids of the mixture.

12. The method according to claim 10, wherein the chemically unmodified pregelatinized starch is a native starch, preferably said pregelatinized native starch is selected from chemically unmodified pregelatinized pea starch, chemically unmodified pregelatinized corn starch or chemically unmodified pregelatinized waxy corn starch.

13. The method according to claim 10, wherein the sweetening agent is a polyol, preferably the polyol is selected from sorbitol, mannitol, maltitol, xylitol, isomalt, erythritol and lactitol or a mixture thereof, preferably maltitol or xylitol.

14. The method according to claim 10, wherein the sugar-coating syrup comprises from 30% to 85% by weight of solids relative to the total weight of the syrup.

15. The method according to claim 10, wherein the polyol is in powder form and the sugar-coating syrup is prepared by mixing the polyol, the chemically unmodified pregelatinized starch with the solvent, with the mixture then being heated.

16. The method according to claim 10, wherein the sugar-coating syrup has a viscosity between 0.1 and 5 Pa·s measured according to Test A at 20° C., preferentially between 0.5 and 3 Pa·s.

17. A dry, pre-mixed sugar-coated composition comprising a mixture of at least one sweetening agent and at least one chemically unmodified pregelatinized starch, with said starch not having undergone chemical modifications,
said composition comprising less than 1% by weight of gum arabic relative to the total weight, preferably said composition being free of gum arabic,
wherein the composition comprises:
between 80 and 99.90% by weight of said sweetening agent relative to the total mass of solids of the composition, preferentially between 90 and 99.90%, most preferentially between 95 and 99% and
between 0, 1 and 20% by weight of said starch relative to the total mass of solids of the composition, preferentially between 0.1 and 10%, most preferentially between 1 and 5%.

18. The composition according to claim 17, wherein the chemically unmodified pregelatinized starch is a native starch, preferably said pregelatinized native starch is selected from chemically unmodified pregelatinized pea starch, chemically unmodified pregelatinized corn starch or chemically unmodified waxy corn starch.

19. The composition according to claim 17, wherein the sweetening agent is a polyol, preferably the polyol is selected from sorbitol, mannitol, maltitol, xylitol, isomalt, erythritol and lactitol or a mixture thereof, preferably maltitol or xylitol.

20. The composition according to claim 17, wherein the average size d50 of the powder ranges from 10 to 1,000 μm, for example, between 100 and 800 μm.
